(19) United States
(12) Patent Application Publication
(10) Pub. No.: US 2002/0108634 A1
(43) Pub. Date: Aug. 15, 2002

(54) Substrate cleaning process and apparatus

(76) Inventor: Daniel McMullen, El Dorado Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/785,023

(22) Filed: Feb. 15, 2001

(51) Int. Cl. B08B 1/04

(52) U.S. Cl. 134/6; 134/18; 15/21.1; 15/77; 15/88.2; 15/88.3

(57) ABSTRACT

Friction force between a scrubbing brush and a substrate during a cleaning process is measured and utilized as a metric in characterizing effectiveness of the cleaning process under a variety of conditions. A friction force setpoint may also be used to perform closed loop control over the cleaning process.

### BACKGROUND OF THE INVENTION

The present invention relates to the manufacture of objects. More particularly, the present invention provides a way to design a sponge or porous polymeric product such as an ultra clean “scrubbing” brush or surface treatment device for use in removing contaminants during the manufacture of integrated circuits, for example. Merely by way of example, the present invention is applied to a scrubbing device for the manufacture of integrated circuits. But it will be recognized that the invention has a wider range of applicability; it can also be applied to the manufacture of a variety of materials, including hard disks for memory devices.

In the manufacture of electronic devices, the presence of particulate contamination is a serious issue. Particulate contamination can cause a wide variety of problems such as mechanical and/or electrical failures. These failures often take the form of reliability and functional problems of electronic devices formed on a substrate. For example, particulate contamination is one of the main sources for lower device yields, increasing the cost of an average functional IC being manufactured.

Particulate contamination can be introduced to the substrate during the fabrication process, for example during the application of abrasive slurry during chemical mechanical planarization (CMP) steps, or during etching processes which leave behind unwanted residue. Each of these processes often introduce the aforementioned impurities onto the surface of the substrate. These impurities generally become bound to the substrate and must often be removed.

A variety of techniques have been used or proposed to remove the impurities. One technique is a conventional rinser, which uses a cascading rinsing fluid such as deionized water to carry away particulate contamination. The cascade rinse utilizes a rinse tank which includes inner and outer chambers, each separated by a partition. In most cases, rinse water flows from a water source into the inner chamber. The rinse water from the inner chamber cascades into the outer chamber. An in-process substrate is typically rinsed in the cascade rinser by dipping it into the rinse water of the inner chamber. A limitation with the cascade rinser is that “dirty water” often exists in the first chamber. The dirty water typically has “particles” which can attach themselves to the substrate. These particles often cause defects in the substrate, thereby reducing the number of defect-less substrates in the manufacturing process. Another limitation with the cascade rinser is that particles having a strong attraction to the substrate cannot be removed by the rinse fluid. Accordingly, the cascade rinse often cannot remove particles from the substrate.

An alternative technique for removing particles is a scrubbing process. The scrubbing technique uses a scrubber with scrubbing brushes or rollers. An example of a scrubber that uses scrubbing brushes is the Synergy™ CMP cleaning system manufactured by Lam Research Corporation of Fremont, Calif. This scrubber has the pair of scrubbing brushes that are cylindrical in shape. The brushes are biased against a substrate and rotated to remove particles.

While conventional scrubbing techniques are effective to remove contamination, improved techniques for monitoring and controlling removal of particles from substrates are desirable.

### SUMMARY OF THE INVENTION

Friction force between a scrubbing brush and a substrate during a cleaning process is measured and utilized as a metric in characterizing a substrate cleaning process under a variety of conditions. Closed loop control over the cleaning process utilizing a friction force setpoint is further possible.

An embodiment of a method for characterizing a substrate cleaning process comprises causing movement of a substrate relative to a cleaning brush in contact with the substrate, and measuring a friction force arising between the substrate and the cleaning brush. The friction force is then correlated to an effectiveness of a cleaning process.

An embodiment of a method for controlling a substrate cleaning process in accordance with the present invention comprises applying a brush against a substrate, and causing motion of the brush relative to the substrate. A friction force arising between the brush and the substrate is measured. A signal reflecting the friction force is communicated, and the friction force signal is compared to a set point. Based upon comparison between the friction force and the setpoint, a process parameter of the substrate cleaning process is adjusted to bring the measured friction force closer to the set point.

An embodiment of an apparatus for cleaning a substrate comprises a support for a substrate, a brush in contact with the substrate and moveable relative to the substrate, and a device applying a load to one of the substrate and the brush and causing a friction force to arise therebetween. The apparatus further comprises a friction force sensor and a controller in electrical communication with the friction force sensor and with the device, such that the controller is able to adjust the load in response to a detected friction force.

These and other embodiments of the present invention, as well as its advantages and features are described in more detail in conjunction with the text below and attached Figures.

### BRIEF DESCRIPTION OF THE DRAWINGS

FIG. 1 shows a simplified cross-sectional view of a scrubbing apparatus.

FIG. 2 is a simplified graph of expected % yield versus friction force for a substrate cleaning process.

FIG. 3A shows a simplified side view of a friction and wear monitor utilized for measuring frictional force.

FIG. 3B shows a simplified plan view of the friction and wear monitor of FIG. 3A.

FIG. 4 shows a simplified schematic view of an apparatus for closed-loop control over CMP slurry dispensing in accordance with one embodiment of the present invention.

### DESCRIPTION OF THE SPECIFIC EMBODIMENTS

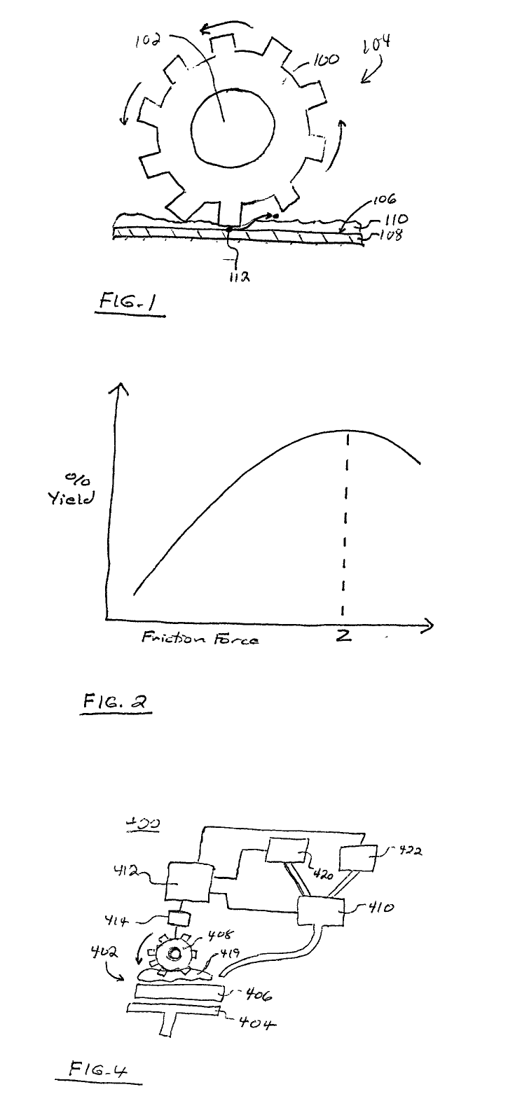

Elastomer brushes formed from polyvinyl acetal (PVA) are used in the semiconductor industry for cleaning substrates under a variety of process conditions. FIG. 1 shows a simplified cross-sectional view of such a conventional scrubbing apparatus.

PVA scrubbing brush 100 is mounted on spindle 102 of cleaning apparatus 104. Spindle 102 and associated brush 100 are rotated, and rotating brush 100 is applied against surface 106 of substrate 108. Substrate surface 106 may feature a variety of materials, including single crystal silicon, silicon oxide, low-k dielectric materials, metals such as Cu, W, or Al, and other materials as are employed in forming integrated circuits.

As rotating brush 100 is applied against surface 106 of substrate 108, liquid cleaning chemistry 110 is also applied to the substrate surface. Cleaning chemistry 110 can be of basic pH, and include for example ammonium hydroxide. Alternatively, cleaning chemistry 110 can be of acidic pH, for example when HF or another acid is used for cleaning a metal on the substrate surface.

As a result of interaction between rotating brush 100 and substrate 108, particulate contamination 112 present on surface 106 of substrate 108 may be dislodged and removed. Frictional force arising between the rotating brush and the substrate is believed to be the main force responsible for particle removal in contact cleaning applications. Cleaning chemistries are employed primarily to reduce the force of adhesion between the particle and substrate, and to prevent reattachment of particles to the substrate once the particles have been dislodged.

Cleaning chemistries also tend to change surface properties of the brush, of the substrate being cleaned, and of the particles themselves. This modification of surface properties can change the frictional force transmitted from the brush to the particulate contamination, and from the brush to the substrate. If such changes in surface properties cause friction force to increase, cleaning effectiveness may be improved.

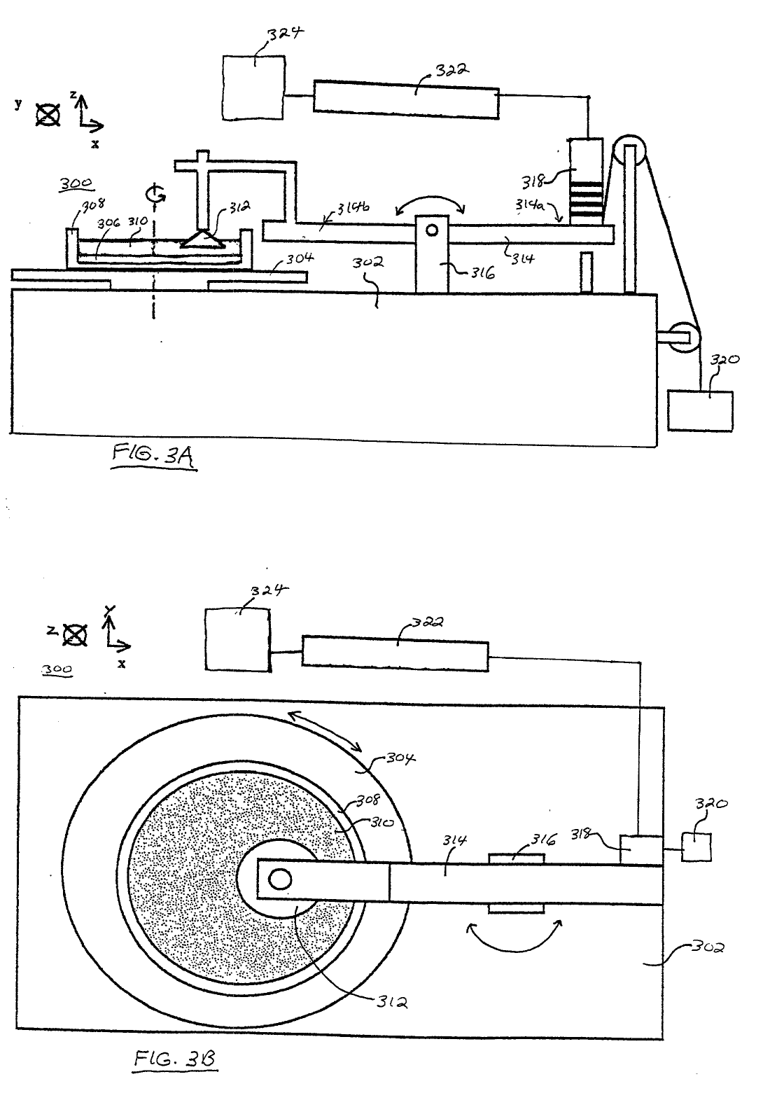

FIG. 2 is a simplified graph of expected % yield versus friction force for a substrate cleaning process. FIG. 2 shows that up to a certain optimum friction force Z, the effectiveness of particle removal and the % yield of the cleaning process are improved. Over and above optimum friction force Z, the % yield drops due to deleterious effects such as scratching and introduction of other forms of surface defects.

In accordance with one aspect of the present invention, friction force may be measured and used as a metric and control variable for designing, optimizing and controlling substrate cleaning processes. The friction force can provide a basis for studying the impact of variation in such cleaning parameters as cleaning chemistry, brush/substrate relative velocities, and downforce due to friction force experienced by a particle in the substrate. The friction force metric can also be utilized to study the impact of different brush roller/consumable material attributes on friction force and hence the force experienced particulate contamination.

Several apparatuses are potentially available to measure friction force in-situ and provide feedback to adjust or control cleaning operational parameters such as rotational speed, down force and chemical flow rate. In accordance with one embodiment of the present invention, an existing friction and wear monitor, for example the 7R-20 friction and wear monitor manufactured by Ducom of Bangalore, India., could be modified to resemble a wet cleaning platform or scrubber as a screening tool. FIG. 3A shows a simplified side view of the 7R-20 friction and wear monitor utilized for measuring frictional force. FIG. 3B shows a simplified plan view of the friction and wear monitor of FIG. 3A.

Modified friction and wear monitor 300 includes base 302 featuring motorized platen 304 rotatable about the z-axis. Silicon wafer 306 is fixed to a glass plate, and the glass plate is fixed within plastic container 308. Plastic container 308 is then filled with deionized (DI) water and attached to platen 304.

Porous polymeric scrubbing brush 310 is attached to non-rotating holder 312, which in turn is attached to arm 314. Arm 314 is supported by pillar 316, but is free to pivot about the z- and y-axes.

A lifting load is applied to first end 314a of arm 314 by hanging weights 320 from load cell 318. As a result, arm 314 pivots about pillar 316 and second end 314b is pressed onto load cell 318. Load cell 318 measures the force applied by brush 310 on second arm end 314b against substrate 306.

Load cell 318 is in electrical communication with controller 322. Controller 322 is in turn in electrical communication with computer 324. Friction force measurements may be taken from computer 324 utilizing Winducom software developed by Duocom for its TR-20 friction and wear monitor.

The friction force measured by the device shown in FIGS. 3A-3B could be utilized to identify the impact of different cleaning chemistry environments upon friction forces that are present in a substrate cleaning system utilizing an elastomer brush in combination with application of a cleaning fluid. The measured friction forces could also be used to identify the effects of different brush materials and brush/substrate movement orientations upon friction force. In this manner, apparatuses in accordance with the present invention could be employed to perform screening studies to understand the impact of different chemistries on the lubricity of the materials, and consequently on the friction force exerted on particulate contamination on the surface of the substrate during the cleaning process.

One advantage of the load cell approach shown in FIGS. 3A and 3B is the ability to rapidly and easily detect a sudden change in back pressure experienced by the brush. For example, as the elastomer brush moves over the substrate, there can be a response that changes the net downforce by pushing up on the lever. This is analogous to the hydroplaning that occurs when a tire is unable to flush water away fast enough and the tire loses contact with the road. Under similar conditions in a substrate cleaning system, friction force would be dramatically reduced and an undesirable sudden change in substrate cleaning would occur.

The above description is merely illustrative of specific embodiments in accordance with the present invention, and one of ordinary skill in the art would recognize many other variations, modifications, and alternatives.

Thus while FIGS. 3A-3B show an embodiment of a device configured to measure frictional force using a lever arm and a load cell, the present invention is not limited to this approach. Other approaches could be utilized to measure frictional force arising during a substrate cleaning process.

For example in one alternative embodiment friction force could be measured using piezo force sensors in contact with the brush or substrate. Such piezo force sensors could measure the force exerted on an elastomer support shaft in the plane of the friction force. Alternatively, piezo force sensors could measure force exerted on a rotational mechanism during rotational contact between a substrate and brush.

Another alternative approach to measuring friction force would be to monitor current drawn during the cleaning process. As shown above, substrate cleaning systems typically involve movement of the substrate against a brush. This movement may take the form of movement of a brush against a fixed substrate, movement of a substrate against a fixed brush, or even a combination of movement of the brush and the substrate. These movements can be rotational or linear (back and forth) in nature.

Movement of the substrate relative to the brush is typically driven by an electrical motor. The current drawn by the motor correlates with resistance to the movement and hence to the friction force. By monitoring the current drawn by the motor during a scrubbing process, friction force can be determined.

In yet another alternative embodiment, an existing cleaning apparatus such as the Synergy™ CMP cleaning system manufactured by Lam Research Corporation of Fremont, Calif., could be outfitted with strain gauges or other types of sensors that would measure the friction force under a variety of processing conditions. Based on the measured friction force, it would be possible to adjust other process variables such as downforce, brush rotational velocity, substrate rotational velocity, composition of cleaning solution, and/or solvent feed rates in order to optimize performance of the cleaning apparatus.

While the above is a full description of specific embodiments of methods and apparatuses in accordance with the present invention, various modifications, alternative constructions and equivalents may be used. For example, FIG. 4 shows a simplified schematic view of an apparatus for closed-loop control over post-CMP cleaning in accordance with one embodiment of the present invention.

Closed loop post-CMP cleaning system 400 comprises cleaning apparatus 402 including platen 404, wafer 406 supported by platen 404, rotatable brush 408, and post-CMP cleaning material dispenser 410. Material dispenser 410 receives a first component of the cleaning fluid from first reservoir 420, and a second component of the cleaning fluid from second reservoir 422, and then mixes these components together to produce cleaning fluid 419.

Operational characteristics of cleaning apparatus 402 are regulated by controller 412. Examples of such controlled operational characteristics include, but are not limited to, the rotational speed of the brush, the force of application of the brush against the surface of the wafer, and the composition and flow rate of cleaning fluid to the substrate.

During operation of post-CMP cleaning system 400, friction force detector 414 detects the friction force of brush 408 against wafer 406. As described above, friction force detector 414 may take the form of a load cell, a current draw monitor, a piezo force sensor, or a variety of other devices. In response to the sensed friction force, friction force detector 414 transmits a signal to controller 412. Controller 412 receives the signal and compares the received signal to a predetermined setpoint. Depending upon a comparison between the received signal and the setpoint, controller 412 may vary operational parameters to bring the detected friction force of the post-CMP process back toward the set point. For example, where the detected friction force is lower than the set point, controller 412 could increase the friction force by increasing the applied force of the brush against the substrate. Alternatively, controller 412 could increase rotational velocity of the brush relative to the substrate in order to increase friction force. Operational parameters other than applied brush force or brush speed could similarly be controlled in response to a feedback signal. Moreover, a combination of such operational parameters could be altered to achieve the desired friction force.

By monitoring a feedback signal reflecting frictional force and then altering process parameters to maintain a consistent friction force, methods and structures in accordance with embodiments of the present invention could perform closed loop control over post-CMP cleaning processes. Such closed loop control would enable post-CMP cleaning to be performed consistently from wafer to wafer, with minimum manual supervision required by the operator.

A large number of embodiments of methods and apparatuses in accordance with the present invention are possible. Therefore, the above description and illustration of various specific embodiments should not be taken as limiting the scope of the present invention which is defined by the appended claims.

What is claimed is:

1. A method for characterizing a substrate cleaning process comprising:
causing movement of a substrate relative to a cleaning brush in contact with the substrate;
measuring a friction force arising between the substrate and the cleaning brush; and
correlating the friction force to an effectiveness of a cleaning process.

2. The method of claim 1 further comprising:
applying a cleaning solution between the substrate and the cleaning brush; and
correlating the friction force to the cleaning solution.

3. The method of claim 1 further comprising:
rotating the brush against the substrate; and
correlating the friction force to a brush rotational speed.

4. The method of claim 1 further comprising:
rotating the substrate against the brush; and
correlating the friction force to a substrate rotational speed.

5. The method of claim 1 wherein the friction force is measured by a load cell.

6. The method of claim 1 wherein the friction force is measured by a piezo force sensor.

7. The method of claim 1 wherein the friction force is measured by monitoring a current drawn by an electrical motor causing the movement of the brush relative to the substrate.

8. A method for controlling a substrate cleaning process comprising:
applying a brush against a substrate;
causing motion of the brush relative to the substrate;
measuring a friction force arising between the brush and the substrate;
communicating a signal reflecting the friction force;
comparing the friction force signal to a set point; and
based upon the comparison between the friction force and the setpoint, adjusting a process parameter of the substrate cleaning process to bring the measured friction force closer to the set point.

9. The method of claim 8 wherein the process parameter adjusted is a speed of rotation of the brush relative to the substrate.

10. The method of claim 8 wherein the process parameter adjusted is a force of application of the brush against the substrate.

11. The method of claim 8 wherein the friction force is measured by monitoring a current drawn by an electrical motor causing the movement of the brush relative to the substrate.

12. The method of claim 8 wherein the friction force is measured by a load cell.

13. An apparatus for cleaning a substrate, the apparatus comprising:
a support for a substrate;
a brush in contact with the substrate and moveable relative to the substrate;
a device applying a load to one of the substrate and the brush and causing a friction force to arise therebetween;
a friction force sensor;
a controller in electrical communication with the friction force sensor and with the device, such that the controller is able to adjust the load in response to a detected friction force.

14. The apparatus of claim 13 further comprising a rotating member in communication with the controller and with the brush, such that the controller is operable to adjust a rotation speed of the brush in response to the detected friction force.

15. The apparatus of claim 14 wherein the controller includes a stored friction force setpoint, the controller configured to adjust at least one of the rotation speed and the load to bring the friction force toward the setpoint.

16. The apparatus of claim 13 wherein the friction force sensor is a load cell.

17. The apparatus of claim 13 wherein the friction force sensor is a current draw monitor.

18. The apparatus of claim 13 wherein the friction force sensor is a piezo force sensor.
